(19) United States
(12) Patent Application Publication
(10) Pub. No.: US 2025/0313098 A1
(43) Pub. Date: Oct. 9, 2025

(54) MOTOR VEHICLE WITH A HIGH-VOLTAGE BATTERY

(71) Applicant: MAGNA STEYR Fahrzeugtechnik GmbH & Co KG, GRAZ (AT)

(72) Inventors: Manuel ERLACHER, Radenthein (AT); Werner SCHWARZL, Lassnitzhoehe (AT)

(73) Assignee: MAGNA STEYR Fahrzeugtechnik GmbH & Co KG, GRAZ (AT)

(21) Appl. No.: 19/096,960

(22) Filed: Apr. 1, 2025

(30) Foreign Application Priority Data
Apr. 8, 2024 (EP) 24169010.6

(51) Int. Cl. B60L 50/64; B60K 1/04; B60L 50/60; H01M 10/613; H01M 10/625; H01M 10/6554; H01M 50/24

(52) U.S. Cl. CPC B60L 50/64; B60K 1/04; B60L 50/66; H01M 10/613; H01M 10/625; H01M 10/6554; H01M 50/24; B60K 2001/0438; B60K 2001/0472

(57) ABSTRACT

A motor vehicle and a method for manufacturing such a motor vehicle. The motor vehicle includes: a high-voltage battery including a battery housing having a downwardly open trough member defining sidewalls and a cover that covers a top region of the sidewalls; a plurality of battery cells are arranged in the battery housing; and a die-cast support plate forming a bottom of the battery housing upon which the battery cells are mounted, and which covers an underside region of the trough member, the support plate including a plurality of spaced apart fastening cages extending upwardly to define space for mounting the battery cells in a vertical direction relative to the support plate such that electrical contacts of the battery cells extend upwardly and bottom regions of the battery extend downwardly.

### CROSS-REFERENCE TO RELATED APPLICATIONS

The present application claims priority under 35 U.S.C. § 119 to European Patent Publication No. EP 24169010.6 (filed on Apr. 8, 2024), which is hereby incorporated by reference in its complete entirety.

### TECHNICAL FIELD

The present disclosure relates to a motor vehicle having a high-voltage battery and to a method for producing such a motor vehicle.

### BACKGROUND

It is known that high-voltage batteries can be installed in motor vehicles, in particular as a drive battery for providing electrical energy for driving the motor vehicle. The battery then has a battery housing which accommodates the cell modules. Battery housings are usually assembled from various individual parts. The battery housing is installed in an underbody via screws and is removable. The impermeability of the vehicle body is ensured via appropriate components in the undercarriage and is independent of the battery housing. In this case, apart from at the screw holes, there is usually a gap of at least a few millimetres between the battery and the vehicle structure in order to avoid rubbing during operation (noise, corrosion, etc.) but also to avoid collision-free assembly. For maintenance or repairs, the entire battery unit has to be removed from the vehicle.

### SUMMARY

The present disclosure addresses the problem of specifying a motor vehicle having a high-voltage battery, wherein the high-voltage battery has a small space requirement such that the energy content in the high-voltage battery can be increased and thus the range of the vehicle is increased, with the weight and production costs also being low. The present disclosure also addresses the problem of specifying a simple and cost-effective method for producing such a motor vehicle.

The problem is solved by a motor vehicle having a high-voltage battery, wherein the high-voltage battery comprises a battery housing, wherein the battery housing comprises sidewalls and a cover that covers the sidewalls at the top, wherein a plurality of battery cells are arranged in the battery housing, wherein the sidewalls and the cover are formed in one piece by a downwardly open trough member, wherein a support plate forms the bottom, covering the underside of the trough member, of the high-voltage battery, wherein the support plate is a die-cast component, wherein the support plate integrally forms fastening cages for receiving the battery cells, wherein the battery cells are mounted in the fastening cages in a manner standing on the support plate such that the electrical contacts of the battery cells are directed upwards and the cell bottoms are directed downwards.

In accordance with the present disclosure, a high-voltage battery has a battery housing which, in contrast to conventional designs, does not use separate lateral housing and frame components and a separate cover, but rather a trough member which forms the sidewalls and the cover, located at the top when installed in the vehicle, of the battery housing. In a simple and cost-effective manner, this upside-down trough member can form the cover and walls of a battery housing which can be equipped with further battery components, in particular battery cells, and can be integrated into the structure of the vehicle body. The trough member can, in this case, for example directly adjoin the floor pan of the motor vehicle or be spaced apart therefrom.

A preferably solid support plate forms the bottom of the battery housing, onto which the trough member is placed as a cover and is preferably fastened. The support plate is produced as a die-cast component and is sufficiently solid to receive the battery cells. The die-cast component integrally also forms fastening cages int which the battery cells can be introduced.

Dispensing with separate additional components, such as a separate battery cover or separate side parts and fastening parts for receiving the battery cells, represents a cost and weight advantage. As a result of this solution, the energy content in the high-voltage battery can also be increased and thus the range of the vehicle can be increased. The crash and torsional rigidities can remain high-quality.

A modular design of the battery cells can be replaced in this battery solution by a cell-to-pack arrangement, with the result that higher energy density with the same installation space can be realized.

The battery cells can be mounted on the support plate, which forms the bottom of the battery housing, in particular into fastening cages of the support plate, in a simple and cost-effective manner in a pre-assembly process, for example at a supplier, preferably directly in the form of battery cells without being installed in a battery module. After the support plate has been equipped with the battery cells, and preferably following the electrical connection of the battery cells, the fully equipped support plate can be joined to the trough member, in particular screwed thereto, in order to close the battery housing.

The finished high-voltage battery can then be fitted in a vehicle body, preferably from below, in a remaining supporting structure of the motor vehicle, and in particular be mounted on side sills of the motor vehicle. Mounting preferably takes place using mechanical joining elements such as screws or rivets.

Developments of the present disclosure are specified in the dependent claims, the description and the appended drawings.

Preferably, the cover is fastened to the support plate and is particularly preferably screwed to the support plate. A seal is preferably arranged in the region of the fastening, in particular of the screw connection, in order to seal off the trough member with respect to the support plate.

Particularly preferably, at least one or more planar cooling plates are arranged on the support plate, beneath the battery cells.

The support plate preferably forms an underride guard of the motor vehicle. Accessibility to the battery cells can be ensured from below, via the preferably removable support plate, which serves as an underride guard at the same time.

Preferably, the cover of the trough member is arranged beneath a floor pan of the motor vehicle. Seat cross members are preferably fastened to the floor pan of the motor vehicle, in particular adhesively bonded and/or screwed to the floor pan.

A planar fire protection element is preferably arranged beneath the cover of the trough member and above the battery cells, i.e. between the cover and battery cells. The fire protection element can be fastened to the cover, for example adhesively bonded and/or screwed thereto.

Preferably, the support plate has been mounted, preferably adhesively bonded and/or screwed, from below on a remaining supporting structure of the motor vehicle, preferably on side sills of the motor vehicle. The sill may have been produced, for example, as a shell construction or from extruded sections.

Preferably, a plurality of longitudinal members and/or cross members of the supporting structure of the motor vehicle are arranged within the trough member of the high-voltage battery. The longitudinal members and/or cross members may be formed integrally by the support plate.

Preferably, the fastening cages for receiving the battery cells are formed partially or entirely by the longitudinal members and/or by the cross members, such that the battery cells are mounted between the longitudinal members and/or between the cross members in a manner standing on the support plate. The fastening cages can thus be formed only by the longitudinal members or only by cross members. The fastening cages may, for example, be formed only by two parallel sidewalls, or by four boundary walls. Longitudinal members and crossmember may, for example, jointly form four bounding walls of the fastening cages.

Preferably, the battery cells are each mounted in the intermediate spaces between the longitudinal members and/or cross members in a manner standing on the longitudinal members and/or on the cross members, such that a plurality of parallel rows of battery cells extend between the longitudinal members and/or cross members.

The battery cells may be mounted individually or be mounted in a manner combined into battery cell modules. The high-voltage battery can thus have battery modules mounted in a standing manner.

In the support plate, in the form of a one-piece cast component, it is also possible for a discharge system for venting gases to be formed.

A method in accordance with the present disclosure for producing a motor vehicle, as described above, may provide that the trough member is produced as a die-cast component, in particular in a so-called “megacasting” process.

A method in accordance with the present disclosure for producing a motor vehicle, as described above, may provide that, in a pre-assembly process, the battery cells are fitted on the support plate into the fastening cages, then the trough member is joined to the support plate, to produce the high-voltage battery, and then the pre-assembled high-voltage battery is mounted from below in a remaining supporting structure of the motor vehicle, and is preferably fastened to side sills of the motor vehicle.

At least one planar cooling element, i.e. a cooling plate, may be arranged, for example placed, on the support plate before the battery cells are mounted. Then, the battery cells are fitted on the support plate, in particular into the fastening cages. Then, the battery cells can be interconnected. Then, the support plate and the trough member can be screwed together. The support plate is embodied as a one-piece cast part, together with the fastening cages.

After the support plate has been screwed to the trough member in order to form the housing, the cells can be connected to plug connections on an end face of the housing, for example through an opening. Then, a closing plate, which also contains the plug connections, can be screwed onto the housing in a gastight manner.

The pre-assembly of the battery housing can take place in the uninstalled state, outside the motor vehicle to be produced.

The pre-assembled battery can be placed on an assembly line and installed in the vehicle from below via conventional manipulation devices.

The pre-assembled high-voltage battery can be introduced from below into a remaining supporting structure of the motor vehicle and mounted there, preferably fastened to side sills of the motor vehicle, for example screwed thereto.

### DRAWING

The present disclosure is described in the following text by way of example with reference to the drawing.

FIG. 1 is a sectional view of a portion of a motor vehicle in a transverse direction of the vehicle (X-section), in accordance with the present disclosure.

### DESCRIPTION

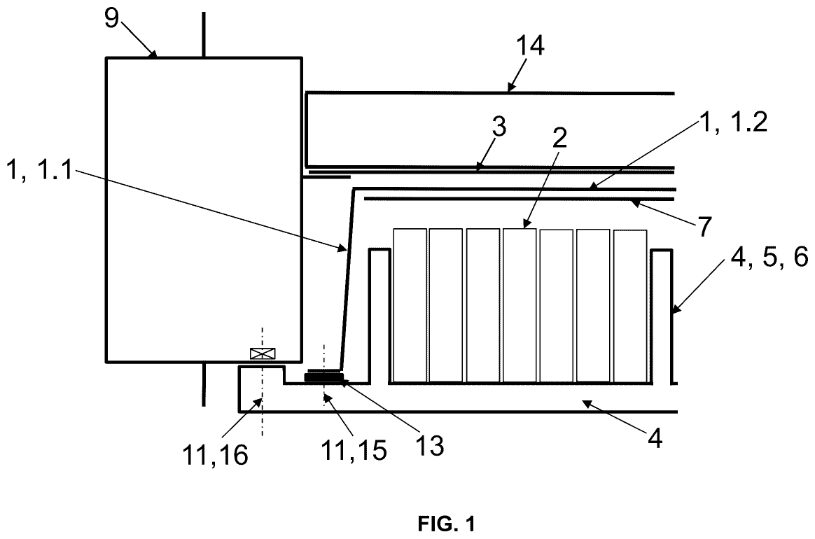

FIG. 1 is a schematic illustration of a high-voltage battery in a trough member 1 of a motor vehicle, in a transverse direction, in accordance with the present disclosure. The vehicle is thus seen from the front.

The partially illustrated motor vehicle comprises a high-voltage battery, which comprises a battery housing. The battery housing comprises sidewalls 1.1 and a cover 1.2 that covers the sidewalls 1.1 at the top. The sidewalls 1.1 and the cover 1.2 are formed in one piece by a downwardly open trough member 1.

A plurality of battery cells 2 are arranged in the battery housing, i.e. in the trough member 1. The battery cells 2 are mounted on a support plate 4 in a manner standing within the trough member 1, such that the electrical contacts of the battery cells 2 are directed upwards and the cell bottoms are directed downwards. The battery cells 2 are mounted on a support plate 4, wherein the support plate 4 forms fastening cages 6. The support plate 4 is a cast component.

Planar cooling plates may be arranged on the cell support 6, beneath the battery cells 2.

The cover 1.2 of the trough member 1 extends beneath a floor pan 3 of the motor vehicle, parallel to the floor pan 3. Seat cross members 14 may be fastened to the floor pan 3, for example screwed thereto.

A planar fire protection element 7 is arranged beneath the cover 1.2 of the trough member 1 and above the battery cells 2.

Laterally, the cover 1.2 of the trough member 1 transitions into sidewalls 1.1 of the battery housing. The sidewalls 1.1 are then joined, in a bottom flange region, to the support plate 4, specifically fastened by a screw connection 11 at a fastening point 15 of the trough member 4. Arranged in the region of the screw connection 11 is a seal 13, which provides sealing between the trough member 1 and support plate 4. In addition or as an alternative to the screw connection, the trough member 1 can also be adhesively bonded to the support plate 4.

The support plate 4 is mounted on a remaining supporting structure of the motor vehicle, specifically mounted on side sills 9 of the motor vehicle, and preferably mounted from below. The fastening takes place at fastening points 16 of the support plate 4 via screw connections 11, preferably additionally using adhesive.

A plurality of longitudinal members 5 of the supporting structure of the motor vehicle are arranged within the trough member 1 of the high-voltage battery. The longitudinal members 5 are formed integrally by the support plate 4.

The fastening cages 6, for receiving the battery cells 2, are formed at least partially or entirely by the longitudinal members 5. The battery cells 2 are mounted in a standing manner on the support plate 4 between the longitudinal members 5, preferably without forming modules. Cross members may be arranged in the trough member 1 normally to the longitudinal members 5.

The battery cells 2 may be fastened to the longitudinal members 5 and/or to cross members via mechanical joining elements, such as screws, i.e. for example screwed thereto.

The support plate 4 forms the bottom, covering the trough member 1 on its underside, of the high-voltage battery. The support plate 4 is in the form of a solid component. The support plate 4 may contribute substantially to absorbing forces from the supporting structure of the motor vehicle. In contrast thereto, the trough member 1 is preferably a non-load-bearing component and can therefore be produced in a lightweight and cost-effective manner.

With this design, a battery cover, namely the trough member 1 comprising the cover part 1.2 of the trough member and the sidewalls 1.1 of the trough member, can thus be placed directly on a solid support plate 4 for the battery cells 2 and screwed thereto.

This already results in a closed housing, in the case of which it is possible to dispense with an encircling supporting frame. The support plate 4 furthermore has integrated fastening points with which the battery can be screwed to the underbody, for example to a sill 9. The support plate 4 for the battery cells 2 may be produced as a one-piece cast component. The support plate 4 upwardly forms pockets, namely the fastening cages 6, into which the battery cells 2 can be directly inserted without previously needing to be combined to form modules.

The pre-assembly of the battery takes place preferably in the uninstalled state, for example, at a supplier.

First of all, the cooling plates are placed in the support plate 4, and then the cells 2 are inserted into the support plate 4 from above and connected electrically together.

Finally, the cover, i.e. the trough member 1, is screwed into the support plate 4 and the battery is electrically tested and seal-tested.

Subsequently, the battery is supplied as a finished module to the vehicle assembly line and can be screwed to the vehicle.

An essential advantage of this arrangement is the saving of the frame, this being associated with a cost and weight reduction. The integration of a plurality of components in the bottom region to form the support plate also means less complexity of manufacture. The modular design of the battery cells can, in the case of this battery, be replaced by a cell-to-pack arrangement, with the result that a higher energy density with the same installation space can be realized.

In the support plate 4, as a one-piece cast component, it is also possible for a discharge system for venting gases in the event of thermal runaway to be integrated, this meaning an additional advantage compared with conventional welded frame batteries.

The battery modules 2 are in this case arranged in a standing manner on the support plate 4. The support plate 4 is embodied at the same time as an underride guard and is, for example, removable again.

After the support plate 4 has been screwed to the trough member 1, the cells 2 are brought into contact with plug connections on the end face of the housing through an opening. Then, a closing plate, which also contains the plug connections, is screwed onto the housing in a gastight manner.

The maintenance or repair of the battery cells 2 can be carried out from above in the uninstalled state of the support plate 4.

### LIST OF REFERENCE SYMBOLS

1 Trough member
1.1 Trough member sidewall
1.2 Trough member cover
2 Battery cells
3 Floor pan
4 Support plate
5 Longitudinal member
6 Fastening cage
7 Fire protection element
9 Sill
11 Screw connection
13 Seal
14 Seat cross member
15 Fastening point of trough member
16 Fastening point of support plate

What is claimed is:

1. A motor vehicle, comprising:
a high-voltage battery including a battery housing having a downwardly open trough member defining sidewalls and a cover that covers a top region of the sidewalls;
a plurality of battery cells are arranged in the battery housing; and
a die-cast support plate forming a bottom of the battery housing upon which the battery cells are mounted, and which covers an underside region of the trough member, the support plate including a plurality of spaced apart fastening cages extending upwardly to define space for mounting the battery cells in a vertical direction relative to the support plate such that electrical contacts of the battery cells extend upwardly and bottom regions of the battery extend downwardly.

2. The motor vehicle of claim 1, wherein the cover is mechanically fastened via screw connection to the support plate.

3. The motor vehicle of claim 1, wherein the support plate forms an underride guard of the motor vehicle.

4. The motor vehicle of claim 1, further comprising a plurality of cooling plates arranged on the support plate, beneath the battery cells.

5. The motor vehicle of claim 1, wherein the cover is arranged beneath a floor pan of the motor vehicle.

6. The motor vehicle of claim 1, further comprising a planar fire protection element arranged beneath the cover and above the battery cells.

7. The motor vehicle of claim 1, further comprising a sills to which the support plate is mounted via screw connection from below.

8. The motor vehicle of claim 7, wherein the sills include a plurality of longitudinal members arranged in the trough member.

9. The motor vehicle of claim 8, wherein the longitudinal members are formed integrally with the support plate.

10. The motor vehicle of claim 9, wherein the fastening cages are formed at least partially by the longitudinal members.

11. A method for manufacturing the motor vehicle of claim 1, comprising:
conducting a pre-assembly process that includes:
mounting the battery cells on the support plate in the fastening cages,
attaching the trough member to the support plate to produce the high-voltage battery, and then
mounting a pre-assembled high-voltage battery from below to side sills of the motor vehicle.
